(19) United States
(12) Patent Application Publication
(10) Pub. No.: US 2008/0101721 A1
(43) Pub. Date: May 1, 2008

(54) DEVICE AND METHOD FOR IMAGE CORRECTION, AND IMAGE SHOOTING APPARATUS

(75) Inventor: Yukio Mori, Hirakata City (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi City (JP)

(21) Appl. No.: 11/876,057

(22) Filed: Oct. 22, 2007

(30) Foreign Application Priority Data
Oct. 25, 2006 (JP) JP2006-289944

(51) Int. Cl. G06K 9/40

(52) U.S. Cl. 382/275

(57) ABSTRACT

The correcting device includes a flicker correction circuit installed in an image shooting apparatus, which is configured to employ a complementary metal oxide semiconductor image sensor for shooting an image in a rolling shutter mode. An image is divided into M pieces in a vertical direction and N pieces in a horizontal direction. Then, areal average values are calculated by averaging pixel signals for each of the divided areas while an average of the areal average values for multiple frames are calculated for each of the divided areas, thereby calculating areal reference values that lack flicker components. A current frame of the image is corrected by use of the areal correction coefficients calculated from ratios of areal reference values to areal average values on the current frame.

### CROSS REFERENCE TO RELATED APPLICATIONS

This application claims priority based on 35 USC 119 from prior Japanese Patent Application No. P2006-289944 filed on Oct. 25, 2006, entire contents of which are incorporated herein by reference.

### BACKGROUND OF THE INVENTION

1. Field of the Invention

The present invention relates to an image correction device, an image correction method for correcting a provided image, and to an image shooting apparatus utilizing the device and the method. More specifically, the present invention relates to a technique for correcting flickers and the like that may occur when an image is shot in a rolling shutter mode under fluorescent-lamp lighting or the like.

2. Description of Related Art

Image shooting using an image pickup device (such as an XY address type CMOS image sensor) that features a rolling shutter under a fluorescent lamp lighted up by direct employment of a commercial alternating-current power source may result in luminance unevenness in a vertical direction or luminance flickers (so-called fluorescent light flickers) in a time direction in each image. This is due to the fact that while a fluorescent lamp functioning as a light source blinks at a frequency twice as high as a frequency of its commercial alternating-current power source, the rolling shutter cannot expose all pixels simultaneously unlike a global shutter.

Japanese Patent Application Laid-open Publication No. Hei 11-122513 discloses a method of flicker correction that purports to resolve this problem. This flicker correction method obtains vertical intensity distribution by integrating outputs from a CMOS image sensor in a horizontal direction and calculates flicker components of a vertical direction in a current frame, using the vertical intensity distribution in multiple frames. Then, an original image (a shot image before correction) is corrected by calculating a correction coefficient from the calculated flicker component and multiplying the correction coefficient with an image signal for the current frame.

By using this method, it is possible to remove the flicker components from an original image 200 that contains the flicker components and to obtain a corrected image 201 as shown in FIG. 10. In FIG. 10, curved line 202 shows the vertical intensity distribution of original image 200.

Here, it is necessary to acknowledge a frequency of luminance fluctuation of the fluorescent lamp (in other words, the frequency of the commercial alternating-current power source that energizes the fluorescent lamp) in advance for performing the above-described flicker correction. In this context, the following is a known method for detecting this frequency. A photodiode dedicated to flicker detection is included in an image pickup device. During use, a detection signals of the photodiode are read out synchronously with a vertical synchronizing signal and the frequency is detected according to the detection signal. Alternatively, as disclosed in Japanese Patent Application Laid-open Publication No. 2003-18458, the frequency is detected according to an output signal from an image pickup device without using a photodiode dedicated to flicker detection.

It is possible to say that the method disclosed in Japanese Patent Application Laid-open Publication No. 11-122513 is effective when all light sources for an entire shot region consist of a fluorescent lamp. However, it is ineffective when the shot region is illuminated by use of mixed light sources, such as a fluorescent lamp and a light source other than the fluorescent lamp.

For example, a case of shooting a picture of a room will be assumed with reference to FIG. 11. In FIG. 11, rectangle 210 is surrounded by solid lines shows an entire shot region. The entire shot region 210 includes diagonal-lined region 211 illuminated by the sunlight and non-diagonal-lined region 212 illuminated by a fluorescent lamp. For example, a window is disposed in diagonal-lined region 211 and exhibits an outdoor view while non-diagonal-lined region 212 exhibits an indoor view.

FIG. 12 shows original image 220, which corresponds to shot region 210 as illustrated in FIG. 11. Curved line 222 represents the vertical intensity distribution of original image 220. If the entire region of original image 220 is exposed to a correction process as shown in FIG. 10, then corrected image 221 will be generated.

While the correction coefficients are calculated by use of vertical intensity distribution 222, the correction coefficients for horizontal lines where the sunlight and the fluorescent lamp are mixed, are influenced by sunlight factors. Accordingly, in corrected image 221, flickers are not completely corrected in an upper left region 223, which exhibits the indoor view. In addition, luminance unevenness or flickers may be newly observed in upper right region 224 that exhibits the outdoor view, and which is not supposed to suffer from such luminance unevenness or flickers.

Therefore, it is an object of the present invention to provide an image correction device and an image correction method capable of appropriately reducing flickers and the like irrespective of light source mixtures, and to provide an image shooting apparatus that employs the device and the method.

### SUMMARY OF THE INVENTION

In one aspect of the invention, there is provided an image correction device configured to accept an output from an image pickup device for shooting an image while changing exposure timing among different horizontal lines and to correct an original image expressed by the output. Here, the image correction device includes an areal correction coefficient calculation unit configured to divide the original image in a vertical direction and in a horizontal direction and to calculate areal correction coefficients for the respective divided areas, and a correcting unit configured to correct the original image by use of the respective areal correction coefficients.

Another aspect of the invention provides a method for correction of images, which includes receiving an image output from an original image pickup device shooting an image while changing exposure timing among different horizontal lines, dividing the original image in a vertical direction and in a horizontal direction, calculating areal correction coefficients for respective divided areas obtained by this division, and correcting the original image by use of the respective areal correction coefficients.

### BRIEF DESCRIPTION OF THE DRAWINGS

FIG. 1 is an overall block diagram of an image shooting apparatus according to an embodiment of the present invention.

FIG. 2 is a view of an internal configuration of the image shooting unit of FIG. 1.

FIG. 3 shows aspects of images sequentially shot in a high-speed shooting mode in an embodiment under fluorescent light, which is energized by a 50-Hz commercial alternating-current power source.

FIG. 4 is a circuit block diagram of a flicker correction circuit included in the image shooting apparatus of FIG. 1.

FIG. 5 shows aspects of areal division of an image which are defined by the flicker correction circuit of FIG. 4.

FIG. 6 is a view for explaining an interpolation process by the interpolation circuit in FIG. 4.

FIG. 7 is another view for explaining the interpolation process of the interpolation circuit in FIG. 4.

FIG. 8 shows a relation between original images and corrected images in an embodiment.

FIG. 9 is a view for explaining an effect of an embodiment.

FIG. 10 shows a conventional method of flicker correction.

FIG. 11 is a view of a room that is assumed to be a shot region of an image shooting apparatus.

FIG. 12 shows images before and after correction by a conventional method of flicker correction for an image that captures the condition of the room shown in FIG. 11.

### DETAILED DESCRIPTION OF EMBODIMENTS

Now, embodiments of the present invention will be concretely described below with reference to the accompanying drawings. In the respective drawings referenced herein, the same constituents are designated by the same reference numerals and duplicate explanation concerning the same constituents will be basically omitted. Although two examples will be described later, items common to the examples and items referenced in the examples are described first.

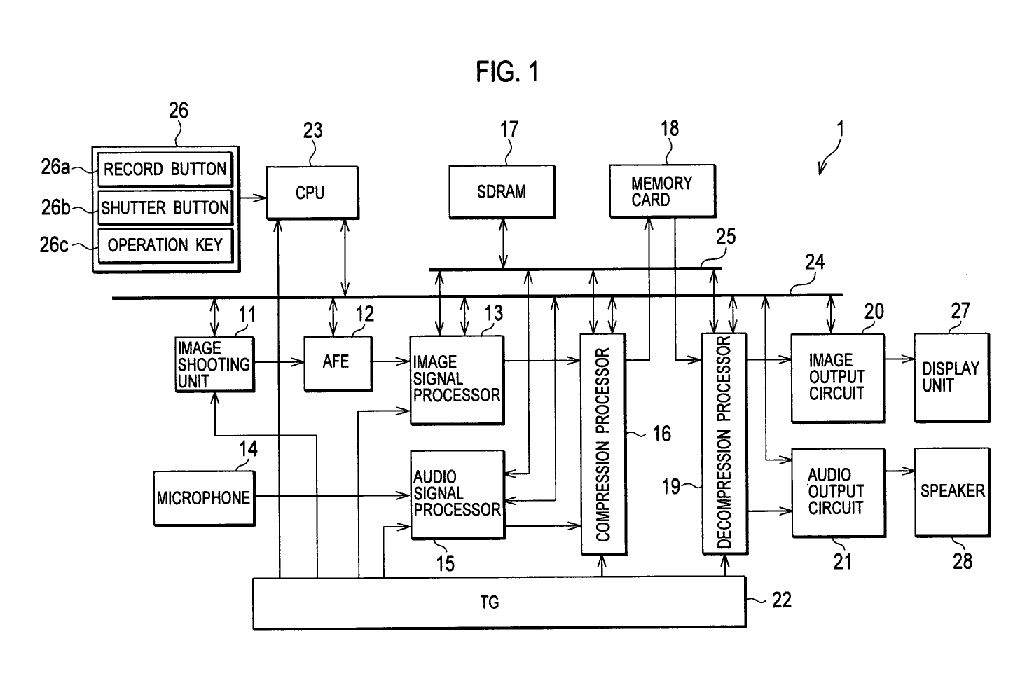

FIG. 1 is an overall block diagram of an image shooting apparatus 1 according to an embodiment of the invention. The image shooting apparatus 1 is a digital video camera, for example. The image shooting apparatus 1 is rendered capable of shooting motion pictures as well as still pictures, and of shooting still pictures simultaneously with shooting of motion pictures.

Image shooting apparatus 1 includes image shooting unit 11, AFE (analog front end) 12, image signal processor 13, microphone 14, an audio signal processor 15, compression processor 16, synchronous dynamic random access memory (SDRAM) 17 as an example of an internal memory, memory card (a storage unit) 18, decompression processor 19, image output circuit 20, audio output circuit 21, TG (timing generator) 22, central processing unit (CPU) 23, bus 24, bus 25, operating unit 26, display unit 27, and speaker 28. Operating unit 26 includes record button 26a, shutter button 26b, operation key 26c, and the like. The respective elements in the image shooting apparatus 1 exchange signals (data) with one another through bus 24 or 25.

First, basic functions of the image shooting apparatus 1 and of the respective elements constituting the image shooting apparatus 1 will be described. The TG 22 generates a timing control signal for controlling timing of respective operations in the image shooting apparatus 1 on the whole and provides the generated timing control signal to respective elements in the image shooting apparatus 1. To be more precise, the timing control signal is transmitted to the image shooting unit 11, image signal processor 13, audio signal processor 15, compression processor 16, decompression processor 19, and CPU 23. The timing control signal includes a vertical synchronizing signal Vsync and horizontal synchronizing signal Hsync.

CPU 23 controls the operations of the respective elements in the image shooting apparatus 1 as a whole. Operating unit 26 accepts operations by a user. Contents of operations given to operating unit 26 are transmitted to CPU 23. SDRAM 17 functions as a frame memory. The respective elements in image shooting apparatus 1 store various data (digital signals) temporarily in SDRAM 17 at the time of signal processing when appropriate.

Memory card 18 is an external storage medium, such as a secure digital (SD) memory card, for example. Although memory card 18 is exemplified as an external storage medium in this embodiment, it is also possible to form the external storage medium by use of one or more randomly accessible storage media (including semiconductor memories, memory cards, optical disks, magnetic disks, and so forth).

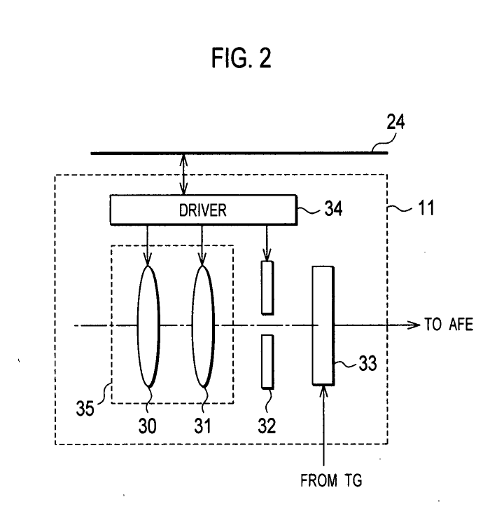

FIG. 2 is a view of an internal configuration of image shooting unit 11 of FIG. 1. By applying color filters or the like to image shooting unit 11, image shooting apparatus 1 may be rendered capable of generating color images at the time of shooting. Image shooting unit 11 includes optical system 35 having multiple lenses containing zoom lens 30 and focusing lens 31, diaphragm 32, image pickup device 33, and driver 34. Driver 34 includes motors and the like for achieving adjustment of motions of zoom lens 30 and focusing lens 31 and an amount of aperture of diaphragm 32.

Light from an object is incident on image pickup device 33 through zoom lens 30, focusing lens 31, and diaphragm 32. These lenses, which constitute optical system 35, focus an image of the object on an imaging surface (a light receiving surface) of image pickup device 33. TG 22 generates a drive pulse synchronized with the timing control signal for driving image pickup device 33 and gives the drive pulse to image pickup device 33.

Image pickup device 33 may be an XY address scanning type complementary metal oxide semiconductor (CMOS) image sensor, for example. The CMOS image sensor may comprise multiple pixels two-dimensionally arranged in a matrix, a vertical scanning circuit, a horizontal scanning circuit, a pixel signal output circuit, and the like on a semiconductor substrate which can have a CMOS structure thereon. In image pickup device 33, an imaging surface is formed the two-dimensionally arranged multiple pixels. The image surface includes multiple horizontal lines and multiple vertical lines.

Image pickup device 33 may have an electronic shutter function and expose pixels by means of a so-called rolling shutter. In the rolling shutter, the timing (time point) of exposure of respective pixels on the imaging surface varies in the vertical direction on a horizontal line basis. That is, exposure timing differs between horizontal lines on the imaging surface. Therefore, it is necessary to consider luminance unevenness in the vertical direction and flickers under a fluorescent lamp lighting, as below.

Image pickup device 33 performs photoelectric conversion of an optical image, which is incident through optical system 35 and diaphragm 32, and sequentially outputs an electric signal obtained by the photoelectric conversion to AFE 12, which is located in a later stage. To be more precise, in each session of image shooting, respective pixels on the imaging surface store signal charges, wherein with charge amounts correspond to exposure time. The respective pixels sequentially output electric signals that correspond to the stored signal charges of AFE 12 located at the later stage. When the optical image incident on optical system 35 remains the same and the aperture of diaphragm 32 remains the same, the magnitude (intensity) of electric signal from image pickup device 33 (i.e. each of the pixels) increases in proportion to the exposure time.

Driver 34 controls optical system 35 according to a control signal from CPU 23 and also controls a zoom factor and the focal length of optical system 35. Moreover, driver 34 controls aperture size of diaphragm 32 according to the control signal from CPU 32. When the optical image incident on optical system 35 remains the same, accumulated incident light onto image pickup device 35 per unit time increases along with an increase in of aperture size of diaphragm 32.

AFE 12 amplifies analog signals outputted from image shooting unit 11 (the image pickup device 33) and converts the amplified analog signals into digital signals. AFE 12 then sequentially outputs the digital signals to image signal processor 13.

Image signal processor 13 generates an image signal representing an image shot by image shooting unit 11 according to the output signal from AFE 12. Such an image will be hereinafter referred to a “shot image”. The image signal includes a luminance signal Y, which represents luminance of the shot image and color-difference signals U and V, which themselves represent colors of the shot image. The image signal generated by the image signal processor 13 is sent to the compression processor 16 and to the image output circuit 20.

Image signal processor 13 is configured to execute a correction process for reducing luminance unevenness in the vertical direction and flickers generated under fluorescent-lamp lighting, as described later. When this correction process is executed, an image signal after the correction process is sent to compression processor 16 and to image output circuit 20.

Moreover, image signal processor 13 may include an autofocus (AF) evaluation value detecting unit configured to detect an AF evaluation value corresponding to an amount of contrast in a focus detection area in a shot image, an autoexposure (AE) evaluation value detecting unit configured to detect an AE evaluation value corresponding to brightness of a shot image, and a motion detecting unit configured to detect a motion of an image in a shot image, and the like (all of these constituents are not shown).

Various signals generated by the image signal processor 13, including the AF evaluation value and the like are transmitted to the CPU 23 when appropriate. The CPU 23 adjusts a position of the focusing lens 31 by way of driver 34 in FIG. 2 in response to the AF evaluation value and thereby focuses the optical image of the object on the imaging surface of image pickup device 33. Meanwhile, CPU 23 adjusts the aperture of diaphragm 32 (and the degree of signal amplification by the AFE 12 when appropriate) by way of driver 34 in FIG. 2 in response to the AE evaluation value and thereby controls the amount of deceived light (brightness of the image). Moreover, hand movement correction and the like are executed according to the movement of the image detected by the motion detecting unit.

In FIG. 1, microphone 14 converts voices (sounds) from outside into analog electric signals and outputs the signals. Audio signal processor 15 converts the electric signals (audio analog signals) from microphone 14 into digital signals. The converted digital signals are sent to compression processor 16 as audio signals that represent voices inputted to microphone 14.

Compression processor 16 compresses the image signals from image signal processor 13 via a predetermined compression method. When shooting a motion picture or a still picture, the compressed image signals are sent to memory card 18. Meanwhile, compression processor 16 compresses the audio signals from audio signal processor 15 via a predetermined compression method. When shooting a motion picture, the image signal from image signal processor 13 and the audio signals from audio signal processor 15 are compressed while temporally linked to each other by compression processor 16. The compressed signals are sent to memory card 18. Here, a so-called thumbnail image is also compressed by compression processor 16.

Record button 26a is a user push button switch for starting and ending shooting of a motion picture (a moving image). Shutter button 26b is a user push button switch for instructing a start and an end of shooting a still picture (a still image). The start and the end of the motion picture shooting are executed in accordance with operations of record button 26a. Still picture shooting is executed in accordance with operation of shutter button 26b. One shot image (a frame image) is obtained in one frame. A length of each frame is set to 1/60 second, for example. In this case, a set of frame images (stream images) sequentially obtained in a 1/60-second frame cycle constitute the motion picture.

Operation modes of image shooting apparatus 1 include a shooting mode capable of shooting a motion picture or a still picture and a replaying mode for reproducing and displaying a motion picture or a still picture stored in the memory card 18. Transitions between these modes are carried out in response to manipulations of operation key 26c.

When the user presses down record button 26a in the shooting mode, image signals for respective frames after the button press and audio signals corresponding thereto are sequentially recorded on memory card 18 through compression processor 16 under the control of CPU 23. That is, shot images for the respective frames are sequentially stored in memory card 18 together with the audio signals. The motion picture shooting session is terminated when the user presses record button 26a again after the motion picture shooting has started. That is, the recording of image signals and audio signals in memory card 18 is terminated and a session of the motion picture shooting is completed.

Meanwhile, a still picture is shot when the user presses shutter button 26b in the shooting mode. To be more precise, the image signal for one frame after pressing the button down is recorded on memory card 18 as an image signal that represents the still picture through compression processor 16 under the control of CPU 23.

In replay mode, when the user operates key 26c, the compressed image signals representing either a motion picture or a still picture recorded on the memory card 18 are sent to decompression processor 19. Decompression processor 19 decompresses the received image signals and sends the decompressed signals to image output circuit 20. Meanwhile, normally in the shooting mode, image signal processor 13 sequentially generates the image signals irrespective of whether the user is shooting motion pictures or still pictures, and the image signals are sent to the image output circuit 20.

Image output circuit 20 converts the provided digital image signals into image signals that are displayable on display unit 27 (such as analog image signals) and outputs the converted signals. Display unit 27 is a display device such as a liquid crystal display, which is configured to display images corresponding to image signals outputted from image output circuit 20.

Meanwhile, when moving images are reproduced in the replaying mode, compressed audio signals that correspond to moving images recorded on the memory card 18 are also sent to decompression processor 19. Decompression processor 19 decompresses the received audio signals and sends the decompressed signals to audio output circuit 21. Audio output circuit 21 converts the provided digital audio signals into audio signals that for output by speaker 28. Speaker 28 outputs audio signals from audio output circuit 21 to the outside as voices/sounds.

The shooting mode includes a normal shooting mode configured to shoot at 60 fps (frames per second) and a high-speed shooting mode configured to shoot at 300 fps. Accordingly, a frame frequency and a frame cycle in the high-speed shooting mode are set to 300 Hz (hertz) and 1/300 second, respectively. Moreover, in the high-speed shooting mode, the exposure time for each pixel on the image pickup device 33 is set to 1/300 second. Transitions between these modes are carried out in response to operation of operation key 26c. Here, concrete numerical values such as 60 or 300 are merely examples and the values can be arbitrarily modified.

Now, an assumption will be made that a light source for illuminating a shot region (an object in a shot region) of image shooting unit 11 includes a non-inverter type fluorescent lamp. Specifically, a shot region of image shooting unit 11 is assumed to be illuminated from one or more non-inverter type fluorescent lamps or mixed light sources including a non-inverter type fluorescent lamp and a light source other than a fluorescent lamp (such as sunlight).

A non-inverter type fluorescent lamp means a fluorescent lamp that is energized by a commercial alternating-current power source without using an inverter. Luminance of the non-inverter type fluorescent lamp cyclically varies at a frequency twice as high as the frequency of the commercial alternating-current power source that energizes the fluorescent lamp. For example, when the frequency of the commercial alternating-current power source is 50 Hz (hertz), the frequency of the luminance change of the fluorescent lamp is 100 Hz (hertz). In the following description, the light source for illuminating a shot region of image shooting unit 11 may be simply referred to as “light source”. In addition, the simple reference to “fluorescent lamp” may also include a “non-inverter type fluorescent lamp”.

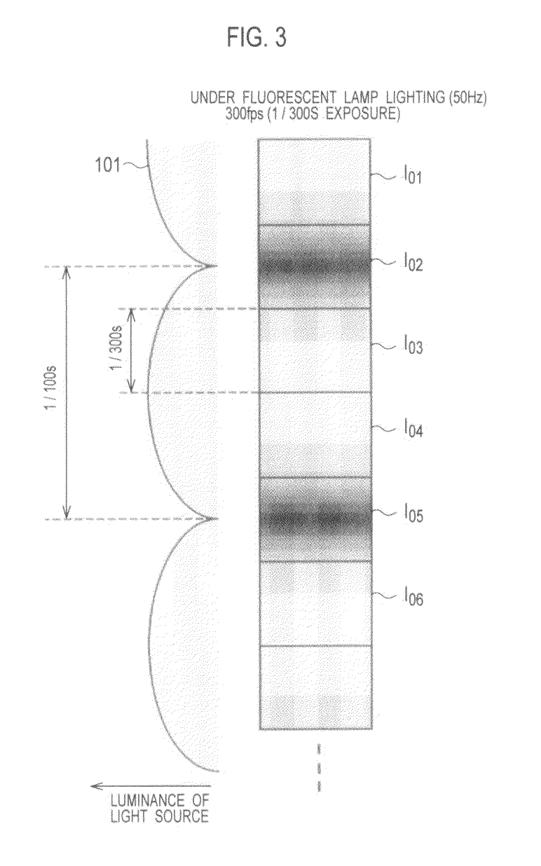

FIG. 3 shows aspects of images sequentially shot in the high-speed shooting mode under fluorescent lamp lighting, which is energized by a 50-Hz commercial alternating-current power source. Reference numeral 101 denotes the luminance of the fluorescent lamp as the light source. A downward direction of the sheet corresponds to the passage of time. First, second, third, fourth, fifth, and sixth frames show up in this order every 1/300 second. Here, shot images I₀₁, I₀₂, I₀₃, I₀₄, I₀₅, and I₀₆ are assumed to be obtained in the first, second, third, fourth, fifth, and sixth frames, respectively. The shot image I₀₁ is expressed by an output signal from image pickup device 33 in the first frame and the shot image I₀₂ is expressed by an output signal from the image pickup device 33 in the second frame. The same applies to the shot images I₀₃ to I₀₆.

Due to the image shooting by use of the rolling shutter, each of the shot images I₀₁ to I₀₆ suffers from luminance unevenness in the vertical direction as shown in FIG. 3, and flickers of luminance are observed along the time direction.

The image shooting apparatus 1 is configured to execute a process to correct these factors. Such a process will be hereinafter referred to as “flicker correction”. A flicker correction circuit configured to execute this process is provided mainly on image signal processor 13. Now, first and second examples will be described below the flicker correction circuit. Items described in one example are applicable to the other examples in the absence of a contradiction.

Note that the shot images I₀₁ to I₀₆ are images before correction in accordance with the flicker correction. For this reason, shot images I₀₁ to I₀₆ are hereinafter referred to as original images I₀₁ to I₀₆ to distinguish these images from images after the correction (hereinafter referred to as “corrected images”).

When the fluorescent lamp blinks at the frequency of 100 Hz and a frame rate is set to 300 fps, it is possible to produce a reference image that contains no flicker components by averaging three frames of the original images. The flicker correction is achieved by multiplying the original image by a correction coefficient that is obtained by comparing this reference image with the original image to be corrected. The following examples employ this principal for flicker correction.

### FIRST EXAMPLE

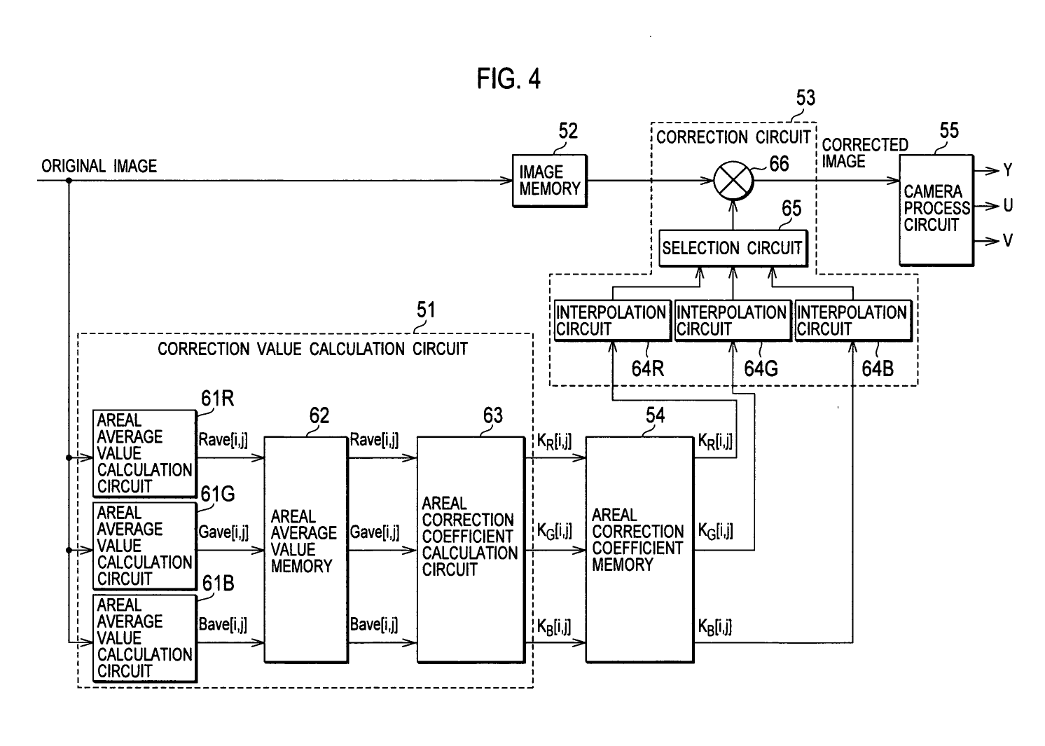

A first example of a flicker correction circuit for image shooting apparatus 1 will now be described. As shown in FIG. 3, it is assumed that the fluorescent lamp blinks at a frequency of 100 Hz and the frame rate is set to 300 fps, FIG. 4 is a circuit block diagram of the flicker correction circuit according to the first example.

The flicker correction circuit in FIG. 4 includes correction value calculation circuit 51, image memory 52, correction circuit 53, and area correction coefficient memory 54. Camera process circuit 55 shown in FIG. 4 is included in the image signal processor 13 but is not a constituent of the flicker correction circuit. It is nevertheless possible to regard the camera process circuit 55 as a constituent of the flicker correction circuit. Meanwhile, correction value calculation circuit 51 includes areal average value calculation circuits 61R, 61G, and 61B, areal average value memory 62, and an area correction coefficient calculation circuit 63. Correction circuit 53 includes interpolation circuits 64R, 64G, and 64B, selection circuit 65, and multiplier 66.

For example, the respective constituents of flicker correction circuit in FIG. 4 are provided in image signal processors 13. However, image memory 52, area correction coefficient memory 54, and areal average value memory 62 may be built either partially or entirely in the SDRAM 17 in FIG. 1. In this case, it is possible to say that the entire flicker correction circuit is constructed from image signal processor 13 and SDRAM 17.

Image pickup device 33 is a single-plate image pickup device, for example. Each pixel on the imaging surface of image pickup device 33 is provided with any one of color filters (not shown) of red (R), green (G) or blue (B). Light passing through the color filter of red, green or blue is incident on each pixel on the imaging surface.

An output signal from AFE 12 corresponding to the pixel provided with the red color filter is called an “R pixel signal”. An output signal from AFE 12 corresponding to the pixel provided with the green color filter is called a “G pixel signal”. An output signal from AFE 12 corresponding to the pixel provided with the blue color filter is called a “B pixel signal”. The R pixel signal, the G pixel signal, and the B pixel signal are termed “color signals” for indicating information on colors of the image. Meanwhile, the R pixel signal, the G pixel signal, and the B pixel signal are collectively called as “pixel signals”.

A one shot image (either an original image or a corrected image) comprises signals corresponding to each pixel on the imaging surface. A value of the pixel signal (hereinafter referred to as a “pixel value”) for a pixel location increases with an increase in signal charge stored for that pixel location.

Signals representing the original images, i.e. the respective pixel signals, are sequentially sent from AFE 12 to the flicker correction circuit. The flicker correction circuit captures each original image as an inputted image or each corrected image as an image to be outputted after dividing each such image into M pieces in the vertical direction and N pieces in the horizontal direction. Although the contents of such divisions are described with particular attention on the original image, similar manipulations are intended for the corrected image as well.

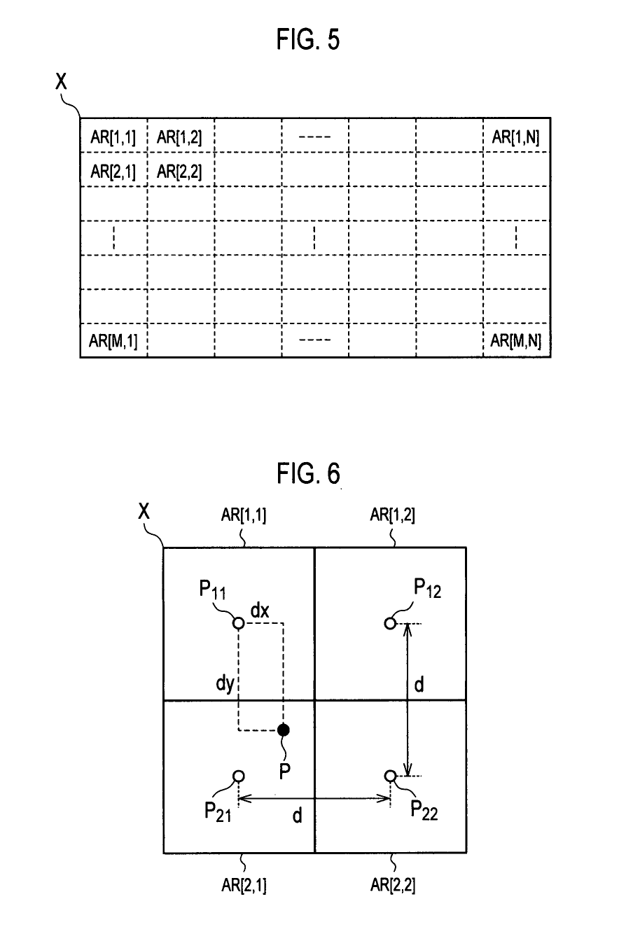

Each original image is divided into (M×N) pieces of areas. FIG. 5 shows an aspect of division of an original image. The values M and N are integers equal to or greater than 2, or may be 16, for example. The values M and N may be identical to or different from each other. The (M×N) pieces of the divided areas are treated as a matrix of M rows and N columns. Each divided area is expressed by AR [i, j] based on the point of origin X of the original image. Here, factors and j are integers that satisfy 1≦i≦M and 1≦j≦N, respectively. The divided areas AR [i, j] sharing the same i value consist of pixels on the same horizontal line. Meanwhile, the divided areas AR [i, j] sharing the same j value consist of pixels on the same vertical line.

For each of divided area of each original image, the areal average value calculation circuit 61R calculates an average value for the R pixel signals of the divided area as an areal average value. The areal average value in the divided area AR [i, j] as calculated by the areal average value calculation circuit 61R will be expressed by R ave [i, j]. For example, in divided area [1, 1], the values of R pixel signals belonging to the divided area [1, 1] (that is, the pixel values of “the pixels being located within the divided area [1, 1] and also having the R pixel signals”) are averaged and the obtained average value is defined as the areal average value R ave [1, 1].

Similarly, for each divided area of each original image, the areal average value calculation circuit 61G calculates an average value of the G pixel signals belonging to the divided area as the areal average value. The areal average value in the divided area AR [i, j] calculated by the areal average value calculation circuit 61G will be expressed by G ave [i, j].

Similarly, for each divided area of each original image, the areal average value calculation circuit 61B calculates an average value of the values of the B pixel signals belonging to the divided area as the areal average value. The areal average value in the divided area AR [i, j] as calculated by the areal average value calculation circuit 61B will be expressed by B ave [i, j].

Here, the areal average value calculation circuit 61R may be configured to calculate a total value of the values of the R pixel signals belonging to each divided area, instead. The same also applies to the areal average value calculation circuit 61G and to the areal average value calculation circuit 61B. In this case, the areal average value in the forgoing description will be read as the areal total value. The areal average value and the areal total value as deemed equivalent to each other. These values may be collectively called “areal signal values”.

The areal average value memory 62 temporarily stores areal average values R ave [i, j], G ave [i, j], and B ave [i, j] respectively calculated for k frames (that is, for k pieces of the original images). The value k is an integer equal to or greater than 2. In this example, since the fluorescent lamp blinks at the frequency of 100 Hz and the frame rate is set to 300 fps, the respective areal average values corresponding to three consecutive frames (i.e. k=3) are stored. In order to correct for flicker in the original image I₀₃ in FIG. 3 to, for example, the areal average values for original images I₀₁, I₀₂, and I₀₃ are stored. In order to apply the flicker correction to original image I₀₄, the areal average values for the original images I₀₂, I₀₃, and I₀₄ are stored.

The value k equals the number of frames of the original images that are necessary for calculating an area correction coefficient. This coefficient (described below) is defined as the value obtained by dividing the lowest common multiple between the frequency of luminance change of the light source and the frame rate (a frame frequency) by the frequency of luminance change of the light source. Therefore, in this case, k is equal to 3. However, it is also possible to define k as an integral multiple of 3. Meanwhile, if the fluorescent lamp blinks at a frequency of 120 Hz and the frame rate is set to 300 fps, then the value k will be equal to 5 (or 10, 15, and so forth).

The contents stored in areal average value memory 62 are given to area correction coefficient calculation circuit 63. Area correction coefficient calculation circuit 63 calculates averages of the areal average values for each type of color signal in each of the divided areas for k frames, and defines the obtained average values as areal reference values. The expression “of each type of the color signals” means “individually of the R pixel signals (the red color signals), the G pixel signals (the green color signals), and the B pixel signals (the blue color signals)”.

The areal reference value of R pixel signals in divided area AR [i, j] will be expressed as R ref [i, j]. The areal reference value of the G pixel signals in the divided area AR [i, j] will be expressed as G ref [i, j]. The areal reference value of the B pixel signals in the divided area AR [i, j] will be expressed as B ref [i, j].

In the embodiment of applying flicker correction to original image I₀₃, for example, the value R ref [1, 1] is defined as the average value of R ave [1, 1] for original images I₀₁, I₀₂, and I₀₃. The value G ref [1, 1] is defined as the average value of G ave [1, 1] for original images I₀₁, I₀₂, and I₀₃. The value B ref [1, 1] is defined as the average value of B ave [1, 1] for the original images I₀₁, I₀₂, and I₀₃. The same applies to the value R ref [1, 2] and so forth. Meanwhile, considering the embodiment of applying a flicker correction to original image I₀₄, for example, R ref [1, 1] is defined as the average value of R ave [1, 1] for original images I₀₂, I₀₃, and I₀₄.

Moreover, the area correction coefficient calculation circuit 63 calculates area correction coefficients for each type of color signal for each of the divided areas.

The area correction coefficient of R pixel signals (the red color signals) for divided area AR [i, j] is expressed by K_{R} [i, j]. The area correction coefficient of the G pixel signals (the green color signals) for divided area AR [i, j] is expressed by K_{G} [i, j]. The area correction coefficient of the B pixel signals (the blue color signals) for divided area AR [i, j] is expressed by K_{B} [i, i].

The area correction coefficient K_{R} [i, j] for applying a flicker correction to original image I₀₃ is defined as the value obtained by dividing the areal reference value R ref [1, 1] for the original images I₀₁, I₀₂, and I₀₃, by the areal average value R ave [1, 1] for the original image I₀₃. The area correction coefficient K_{G} [i, j] for applying a flicker correction to original image I₀₃ is defined as the value obtained by dividing the areal reference value G ref [1, 1] for the original images I₀₁, I₀₂, and I₀₃, by the areal average value G ave [1, 1] for the original image I₀₃. The area correction coefficient K_{B} [i, j] for subjecting the original image I₀₃ to the flicker correction is defined as the value obtained by dividing areal reference value B ref [1, 1] for the original images I₀₁, I₀₂, and I₀₃, by the areal average value B ave [1, 1] for the original image I₀₃. When applying the flicker correction to the original image I₀₄, the value K_{R} [i, j] is defined as the value obtained by dividing the areal reference value R ref [1, 1] for the original images I₀₂, I₀₃, and I₀₄ by the areal average value R ave [1, 1] for the original image I₀₄. The same applies to the values K_{G} [i, j] and the value K_{B} [i, j].

As described above, assuming that a certain piece of the original image focused on as a correction target is referred to as a correction target image, the area correction coefficient calculation circuit 63 calculates the area correction coefficients of each type of color signal for the divided areas of the correction target image via ratioing the areal average values (the areal signal values) for the correction target image and the areal reference values for k pieces of consecutive frames including the frame corresponding to the correction target image

Area correction coefficient memory 54 stores area correction coefficients K_{R} [i, j], K_{G} [i, j] and K_{B} [i, j] for use in the correction circuit 53 that performs flicker correction for the respective original images. The stored contents of the area correction coefficient memory 54 are given to interpolation circuits 64R, 64G, and 64B.

The area correction coefficient represents the correction coefficient applicable to a central pixel in the corresponding divided area. The respective interpolation circuits calculate pixel correction coefficients, which are the correction coefficients for the respective pixels, by means of interpolation. Interpolation circuit 64R calculates the pixel correction coefficients of the R pixel signals for the respective pixels by use of values K_{R} [i, j]. The interpolation circuit 64G calculates pixel correction coefficients of the G pixel signals for the respective pixels via values K_{R} [i, j]. Interpolation circuit 64B calculates pixel correction coefficients of the B pixel signals for the respective pixels via values K_{B} [i, i].

For instance, an embodiment involving the divided areas AR [1, 1], AR [1, 2], AR [2, 1], and AR [2, 2] is considered with reference to FIG. 6. Central pixels of divided areas AR [1, 1], AR [1, 2], AR [2, 1], and AR [2, 2] are indicated respectively by P₁₁, P₁₂, P₂₁, and P₂₂ as shown in FIG. 6.

Now, the R pixel signals are exemplified for simplicity in considering how to determine a correction coefficient K_{RP} for an R pixel signal for a pixel P located inside a square area surrounded by central pixels P₁₁, P₁₂, P₂₁, and P₂₂. On the image, a horizontal distance between the central pixel P₁₁, and the pixel P is defined as dx while a vertical distance between the central pixel P₁₁ and the pixel P is defined as dy. Meanwhile, both the distance between the horizontally adjacent central pixels and a distance between the virtually adjacent central pixels are defined as d. In this case, the pixel correction coefficient K_{RP} is calculated using the following formula (1), provided that formulae (2) and (3) hold true at the same time:

K_{RP}={(d−dy)·K_{X1}+dy·K_{X2}}/d (1)

K_{X1}={(d−dx)·K_{R}[1,1]+dx·K_{R}[1,2]}/d (2)

K_{X2}={(d−dx)·K_{R}[2,1]+dx·K_{R}[2,2]}/d (3)

Note that the above-described liner interpolation is not feasible in an edge area of the image. Accordingly, the pixel correction coefficient for a pixel located in the edge area of the image is deemed to be the same as that of a neighboring pixel for which the pixel correction coefficient can be calculated from the above formulae (1) to (3).

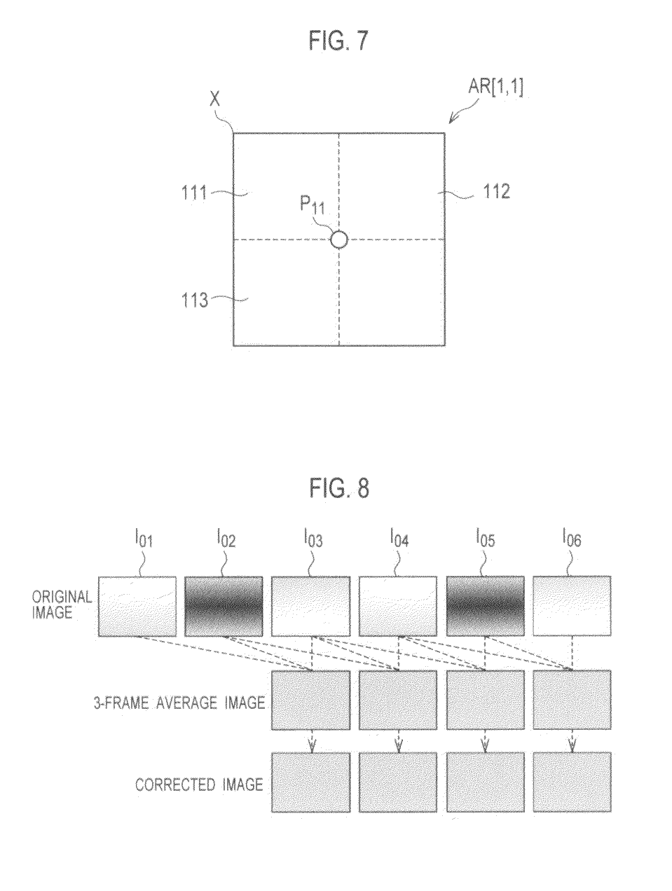

For instance, the divided area AR [1, 1] containing edge areas of the image will be considered with reference to FIG. 7.

In the divided area AR [1, 1], the pixel correction coefficient of a pixel in area 111, which is located on the upper side (toward the point of origin X) of central pixel P₁₁, and on the left side (toward the point of origin X) of central pixel P₁₁, is deemed to be the same as the pixel correction coefficient of the central pixel P₁₁. In divided area AR [1, 1], the pixel correction coefficient of a pixel in area 112, which is located on the upper side of the central pixel P₁₁ and on the right side of central pixel P₁₁, is deemed to be the same as the pixel correction coefficient of a pixel located on an intersection of a vertical line that pixel belongs to and a horizontal line that central pixel P₁₁ belongs to. In divided area AR [1, 1], the pixel correction coefficient of a pixel in area 113, which is located on the lower side of the central pixel P₁₁ and on the left side of the central pixel P₁₁, is deemed to be the same as the pixel correction coefficient of a pixel located on an intersection of a horizontal line that the pixel belongs to and a vertical line that the central pixel P₁₁ belongs to.

Although divided areas AR [1, 1], AR [1, 2], AR [2, 1], and AR [2, 2] are exemplified herein, the interpolation process is executed for other divided areas as well. Moreover, the interpolation process is executed similarly for the G pixel signals and the B pixel signals.

Image memory 52 temporarily stores pixel signals of the original image. When the pixel correction coefficients necessary for flicker correction are calculated by correction circuit 53, the target pixel signals to be corrected are sequentially outputted from image memory 52 to multiplier 66. And synchronized with this, the pixel correction coefficients to be multiplied to the pixel signals are outputted from any of interpolation circuits 64R, 64G, and 64B to multiplier 66 through selection circuit 65. Selection circuit 65 selects and outputs the pixel correction coefficients to be supplied to multiplier 66. Multiplier 66 sequentially multiplies the provided pixel correction coefficients and the pixel signals from image memory 52 for each type of the color signal and outputs the multiplied values to camera process circuit 55. The image expressed by the output signals of multiplier 66 represents the corrected image obtained by applying the flicker correction to the original image.

When applying the flicker correction to the original image I₀₃, the pixel signals of the original image I₀₃ are multiplied by pixel correction coefficients calculated using the pixel signals of the original images I₀₁, I₀₂, and I₀₃ for each type of color signal. In this case, a pixel signal of a certain focused-on pixel in the original image I₀₃ is multiplied by the pixel correction coefficient corresponding to the focused-on pixel. Moreover, as apparent from the above description, the pixel correction coefficient corresponding to the focused-on pixel is calculated by use of area correction coefficients for the divided area that the focused-on pixel belongs to.

That is, an image in the divided area AR [i, j] of a certain original image is corrected by use of the area correction coefficients K_{R} [i, j], K_{G} [i, j], and K_{B} [i, j] for the same divided area AR [i, j].

For example, when the pixel signal corresponding to pixel P shown in FIG. 6 is the R pixel signal, multiplier 66 multiples the pixel signal of the pixel P in the original image I₀₃ by the pixel correction coefficient K_{RP}, which is obtained with the area correction coefficients K_{R} [1, 1], K_{R} [1, 2], K_{R} [2, 1], and K_{R} [2, 2], each of which is calculated by use of the original images I₀₁, I₀₂, and I₀₃. See the formulae (1) to (3).

Camera process circuit 55 converts the output signal from multiplier 66 into the image signal consisting of the luminance signal Y and the color-difference signals U and V. This image signal is the signal after the flicker correction and is sent to the compression processor 16 and/or the image output circuit 20 (see FIG. 1) located at a later stage when appropriate.

FIG. 8 shows a relation between the original images I₀₁ to I₀₆ and the corrected images. Images illustrated between the original images I₀₁ to I₀₆ on a top row and the corrected images on a bottom row are average images of three consecutive frames of the corresponding original images. In the average images and the corrected images, luminance unevenness in the vertical direction and flicker in the time direction are eliminated, or at least reduced.

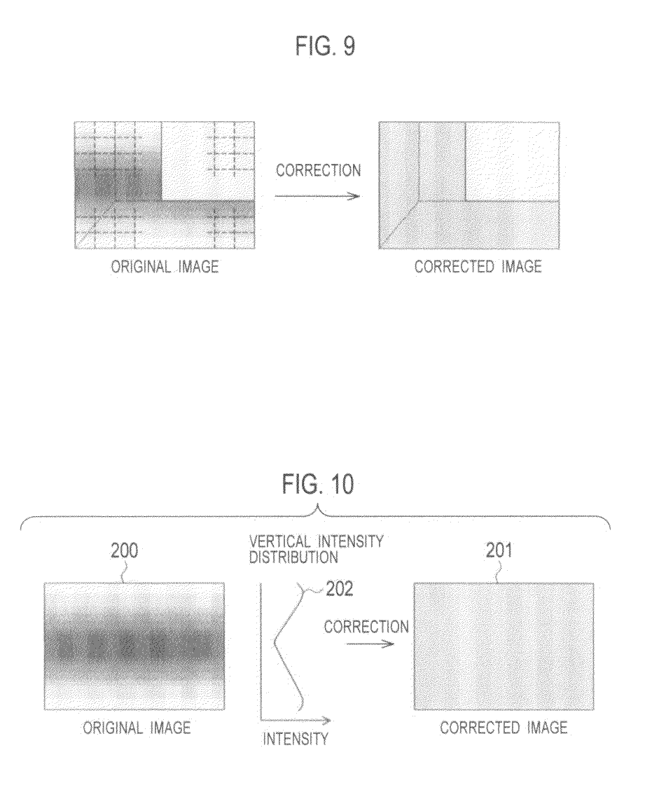

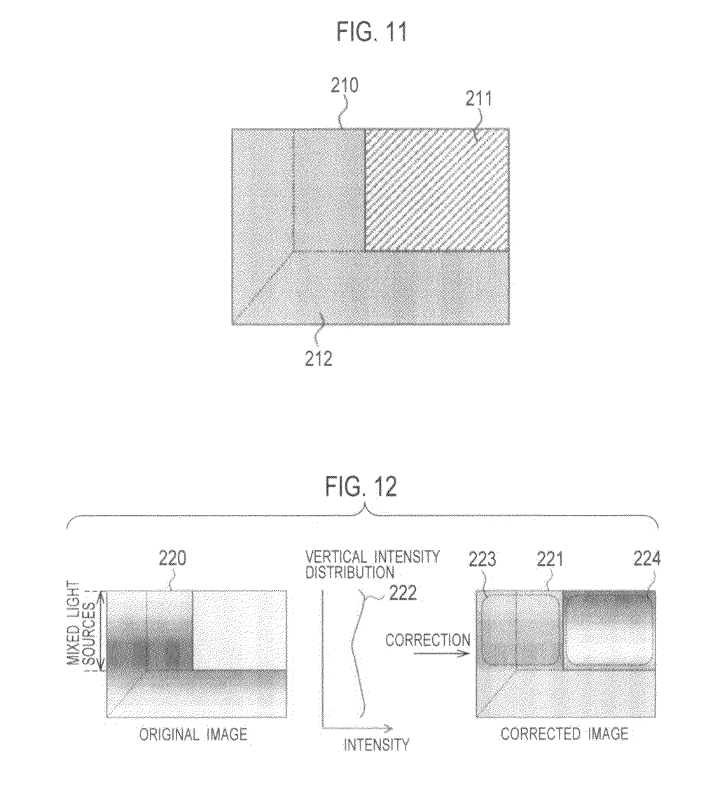

Meanwhile, in the case of the mixed light sources including the fluorescent lamp and the sunlight or/and the like (a light source other than a fluorescent lamp), flicker correction by dividing an original image only in the vertical direction may yield not only insufficient removal of flickers or the like in the divided area employing the fluorescent lamp as the light source but also new flickers or the like in a divided area employing the sunlight or the like as the light source as previously described with reference to FIG. 12. Accordingly, in this example, the original images are divided not only in the vertical direction but also in the horizontal direction and flicker correction occurs using correction coefficients calculated for each of the divided areas. In this way, each divided area is corrected according to the light source and the above-mentioned problems are solved as shown in FIG. 9. That is, flickers or the like in a location of the fluorescent lamp are properly removed while occurrence of new flickers or the like in a location of sunlight or the like as the light source is suppressed. Moreover, the number N of division of the areas in the horizontal direction is set to an arbitrary value, and improvement in the above-mentioned problems will be more significant basically by increasing the number N.

Although this example shows the case where the image pickup device 33 is a single-plate image pickup device, needless to say, it is possible to execute similar flicker correction in the case where the image pickup device 33 is a three-plate image pickup device. When employing the three-plate image pickup device as image pickup device 33, the R pixel signals, the G pixel signals, and the B pixel signals exist in respective pixels in the original image (or the corrected image). In this case, however, it is possible to calculate the respective values such as the areal average values for each type of the color signals as described above, and to execute the flicker correction.

Meanwhile, the number of frames (i.e. the value k) to reference for applying flicker correction to one original image depends on the frequency of luminance change in the light source (in other words, the frequency of the commercial alternating-current power source) as described previously. Therefore, it is appropriate to provide image shooting apparatus 1 with a frequency detector (not shown) for detecting this frequency. It is possible to arbitrarily employ publicly-known or well-known methods to detect this frequency.

For example, the frequency of the luminance change of the light source is detected by placing a photodiode dedicated to flicker detection either inside or outside the image pickup device 33, reading an electric current flowing on the photodiode synchronously with the vertical synchronizing signal V sync, and analyzing a changes in the electric current. As another method, it is possible to detect the frequency easily with an optical sensor. Moreover, it is possible to detect the frequency in a similar manner to that disclosed in Japanese Patent Application Laid-open Publication No. 2003-18458 wherein frequency is detected from signals of image pickup device 33 without using a photodiode dedicated to flicker detection.

### SECOND EXAMPLE

The first example describes inputting color signals as pixel signals and correcting the pixel signals of each type of the color signals, separately. Instead, it is also possible to correct respective luminance signals representing luminance of the respective pixels in the original image. This embodiment is described next as a second example.

In this case, luminance signals are given to the flicker correction circuit as the pixel signals for the respective pixels in the original image. The respective luminance signals for the original image are generated from the output signals of AFE 12 by image signal processor 13. Then, in this case, one circuit is sufficient to provide either the areal average value calculation circuit or the interpolation circuit.

Specifically, for each divided area AR [i, j] of each original image, the areal average value calculation circuit calculates an average value of the values of the pixel signals belonging to the divided area (that is, luminance signals of the pixels in the divided area) as an areal average value Y ave [i, j]. Then, for each divided area AR [i, j], the areal average value calculation circuit calculates an average k frames of the areal average values Y ave [i, j] as an areal reference value Y ref [i, j]. Then, for each of the divided areas AR [i, j], the areal average value calculation circuit calculates an area correction coefficient value K_{Y} [i, j] for the correction target image from a ratio the areal average value Y ave [i, j] for the correction target image to the corresponding areal reference value Y ref [i, j].

As in the first example, the interpolation circuit of the second example calculates the pixel correction coefficient for each pixel from the area correction coefficient value K_{Y} [i, j] by means of liner interpolation. Then, the correction circuit generates the pixel signals (the luminance signals) for the respective pixels in the corrected image by multiplying the pixel signals (the luminance signals) for the respective pixels in the original image by the pixel correction coefficients corresponding to the respective pixels.

For example, when applying the flicker correction to the original image I₀₃, the pixel signals of the original image I₀₃ are multiplied by the pixel correction coefficients calculated by use of the pixel signals for the original images I₀₁, I₀₂, and I₀₃. In this case, a pixel signal of a certain focused-on pixel in the original image I₀₃ is multiplied by the pixel correction coefficient corresponding to the focused-on pixel.

As described above, it is also possible to correct flicker correcting the luminance signals. Nevertheless, a composition ratio of R, G, and B in illumination light using the fluorescent lamp normally fluctuates a little according to the brightness of the illumination. Accordingly, correction only for the luminance signals may cause color changes (color flickers) in the image. From this point of view, the method in the first example is preferred to that in the second example.

### <<Modifications>>

Remarks are provided below regarding modification of the above-described examples. The contents in the respective remarks may be arbitrarily combined unless there is contradiction.

Concrete numerical values indicated in the above description are merely examples and the values can be changed into various numerical values naturally.

The frequency of the commercial alternating-current power source in the United States is set to about 60 Hz (whereas the frequency of the commercial alternating-current power source in Japan is basically set to 60 Hz or 50 Hz). Nevertheless, these frequencies usually have a margin of error (of some percent, for example). Moreover, the actual frame rate and exposure time also have margins of error relative to designed values. Accordingly, the frequency, the cycle, the frame rate, and the exposure time stated in this specification should be interpreted as concepts of time containing some margins of error.

For example, the number of frames (i.e. the value k) to be referenced for applying flicker correction to one original image has been described as, “is defined as the value obtained by dividing the lowest common multiple between the frequency of luminance change of the light source and the frame rate (a frame frequency) by the frequency of luminance change of the light source”. However, the terms “the frequency of luminance change of the light source”, “the frame rate”, and “the lowest common multiple” in this description should be interpreted not as accurate values but as values containing some margins of error.

Meanwhile, the image shooting apparatus 1 in FIG. 1 can be constructed by use of hardware or a combination of hardware and software. Although the aforementioned examples have described the examples of fabricating the area for executing the flicker correction by use of one or more circuits (the flicker correction circuit(s)), the functions of the flicker correction can be implemented by hardware, software or a combination of hardware and software.

When constructing the image shooting apparatus 1 by software, a block diagram of the components implemented by the software represents a functional block diagram of the components. It is also possible to implement all or part of the functions of the flicker correction circuit by describing all or part of the functions as programs and executing the programs on a program execution apparatus (such as a computer).

The flicker correction circuit shown in FIG. 4 functions as an image correction apparatus configured to execute the flicker correction. In FIG. 4, the areal average value calculation circuits 61R, 61G, and 61B function as areal signal value calculation units and the areal average value calculation circuit according to the second example also functions as the areal signal value calculation unit.

This invention encompasses other embodiments in addition to the embodiments described herein without departing from the scope of the invention. The embodiments stated herein are intended to describe the invention but not to limit the scope of the invention. It should be understood that the scope of the invention shall be defined by the description of the appended claims but not by the description in the specification. In this context, the invention encompasses all the forms including the meanings and scope within the equivalents of the claimed invention.

What is claimed is:

1. An image correction device comprising:
an areal correction coefficient calculation unit configured to receive an output of an image from an image pickup device, to divide the image in a vertical direction and in a horizontal direction, and to calculate areal correction coefficients for respective divided areas obtained by this division; and
a correcting unit configured to correct the received image by use of the respective areal correction coefficients.

2. The image correction device as claimed in claim 1,
wherein the correcting unit corrects an image in a divided area of the received image by use of an areal correction coefficient for the divided area.

3. The image correction device as claimed in claim 1,
wherein the area correction coefficient calculation unit calculates area correction coefficients for the respective divided areas by making reference to pixel signals of pixels in the divided areas for a plurality of frames.

4. The image correction device as claimed in claim 3, further comprising:
an areal signal value calculation unit configured to calculate an areal signal value by averaging the pixel signals of the pixels in the divided area for each of the divided areas in each of the received images,
wherein the area correction coefficient calculation unit calculates areal reference values by use of the areal signal values for the plurality of frames and calculates an area correction coefficient for each of the divided areas via ratioing of the areal reference values to the areal signal values.

5. The image correction device as claimed in claim 4,
wherein the pixel signals are color signals and the color signals include a plurality of types,
the areal signal value calculation unit calculates the areal signal values of each type of the color signal for each of the divided areas,
the area correction coefficient calculation unit calculates the areal reference values and the area correction coefficients of each type of the color signal and for each of the divided areas, and
the correcting unit corrects the received image by use of the calculated area correction coefficients of each type of the color signal and for each of the divided areas.

6. The image correction device as claimed in claim 4,
wherein the pixel signals are luminance signals.

7. The image correction device as claimed in claim 3, further comprising:
an areal signal value calculation unit configured to calculate an areal signal value by factoring the pixel signals of the pixels in the divided area for each of the divided areas in each of the received images,
wherein the area correction coefficient calculation unit calculates areal reference values by use of the areal signal values for the plurality of frames and calculates the area correction coefficients for each of the divided areas by ratioing the areal reference values to the areal signal values.

8. The image correction device as claimed in claim 7,
wherein the pixel signals are color signals and the color signals include a plurality of types,
the areal signal value calculation unit calculates the areal signal values of each type of the color signal for each of the divided areas,
the area correction coefficient calculation unit calculates the areal reference values and the area correction coefficients of each type of the color signal and for each of the divided areas, and
the correcting unit corrects the received image by use of the calculated area correction coefficients of each type of the color signal and for each of the divided areas.

9. The image correction device as claimed in claim 7,
wherein the pixel signals are luminance signals.

10. The image correction device as claimed in claim 1,
wherein the correcting unit calculates pixel correction coefficients corresponding to respective pixels in the received image from the respective area correction coefficients by way of interpolation and corrects the received image by use of the respective pixel correction coefficients.

11. The image correction device as claimed in claim 3,
wherein the number of frames of the plurality of frames is determined by ratioing a lowest common multiple of frequency of luminance change of a light source for the image pickup device and a frame change of the image pickup device to the frequency of the luminance change.

12. The image correction device as claimed in claim 1, further comprising:
an image pickup device configured to shoot an image while changing exposure timing among different horizontal lines.

13. A method for correction of images, comprising:
receiving an image output from an image pickup device shooting an image while changing exposure timing among different horizontal lines;
dividing the received image in a vertical direction and in a horizontal direction;
calculating areal correction coefficients for respective divided areas obtained by this division; and
correcting the received image by use of the respective areal correction coefficients.

14. The method as claimed in claim 13,
wherein correcting the received image by use of the respective correction coefficients comprises correcting an image in the divided area of the received image by use of the areal correction coefficient for the same divided area.

15. The method as claimed in claim 13,
wherein calculating areal correction coefficients for respective divided areas obtained by this division comprises calculating the area correction coefficients for the respective divided areas by making reference to pixel signals of pixels in the divided areas for a plurality of frames.

16. The method as claimed in claim 13, further comprising:
calculating an areal signal value by averaging the pixel signals of the pixels in the divided area for each of the divided areas in each of the received images,
wherein calculating areal correction coefficients for respective divided areas obtained by this division includes calculating areal reference values by use of the areal signal values for the plurality of frames and calculating an area correction coefficient for each of the divided areas by use of ratios of the areal reference values to the areal signal values.

17. The method as claimed in claim 16,
wherein the pixel signals are color signals and the color signals include a plurality of types, and wherein
calculating areal correction coefficients for respective divided areas obtained by this division comprising calculating the areal signal values of each type of the color signal for each of the divided areas, and
correcting the received image by use of the respective areal correction coefficients comprises calculating the areal reference values and the area correction coefficients of each type of the color signal and for each of the divided areas, and, correcting the original image by use of the calculated area correction coefficients of each type of the color signal and for each of the divided areas.

18. The method as claimed in claim 16,
wherein the pixel signals are luminance signals.

19. The method as claimed in claim 13,
wherein correcting the received image by use of the respective areal correction coefficients comprises calculating pixel correction coefficients corresponding to the respective pixels in the received image from their respective area correction coefficients by interpolation and correcting the received image by use of the respective pixel correction coefficients.

20. The method as claimed in claim 15,
wherein the number of frames of the plurality of frames is determined by ratioing a lowest common multiple a frequency of luminance change of a light source for the image pickup device and a frame change of the image pickup device to the frequency of the luminance change.
